(19) United States
(12) Patent Application Publication
(10) Pub. No.: US 2018/0177220 A1
(43) Pub. Date: Jun. 28, 2018

(54) PROCESS FOR PRODUCING MUNG BEAN PROTEIN MATERIAL

(71) Applicant: FUJI OIL HOLDINGS INC., Osaka (JP)

(72) Inventors: Hideo SUGANO, Ibaraki (JP); Mitsutaka KOHNO, Ibaraki (JP)

(73) Assignee: FUJI OIL HOLDINGS INC., Osaka (JP)

(21) Appl. No.: 15/837,376

(22) Filed: Dec. 11, 2017

(30) Foreign Application Priority Data
Dec. 22, 2016 (JP) 2016-249273

(51) Int. Cl. A23L 33/16; A23J 3/14

(52) U.S. Cl. CPC A23L 33/16; A23V 2002/00; A23J 3/14

(57) ABSTRACT

An object of the invention is to provide a mung bean protein material having desired water dispersibilty and gel physical property. A mung bean protein material obtained by adding calcium salt to a solution containing mung bean protein, in an amount of 0.04 to 0.5% by weight as calcium based on the solid content, and then drying has excellent water dispersibility and excellent gel physical property.

### TECHNICAL FIELD

The present invention relates to a process for producing a mung bean protein material.

### BACKGROUND ART

In recent years, vegetable protein material has been used for various foods such as beverage powder, baked confectionery, and fish-paste product.

For example, certain soybean protein materials have been added to foods for the purpose of improving water retention and texture based on high solubility and gel physical property thereof. However, such a soybean protein material is unsuitable for beverage use because it forms gel-like film on the surface of the powder in the drying step during powder production, and shows poor water dispersibility.

Some attempts have been made to improve the water dispersibility by adding an emulsifier to the soybean protein material. However, it may be restricted in use because the original flavor is impaired by the emulsifier.

As a technique for improving water dispersibility of vegetable protein material, for example, a method for producing a soybean protein material having good water dispersibility is disclosed, where the method including adjusting a soybean protein-containing solution to pH 5.5 to 8.5, adding a calcium salt to the solution until not occurring the heating coagulation, heating to 80 to 160° C. and cooling to 70° C. or less, adding calcium salt to occur calcium coagulation of the protein, homogenizing before completion of the coagulation, and then spray drying (Patent Document 1).

### PRIOR ART DOCUMENT

### Patent Document

Patent Document 1: JP H06-141783 A

### SUMMARY OF INVENTION

### Problems to be Solved by Invention

In the technique of Patent Document 1, for example, dispersibility of soybean protein is improved by adding 1% by weight of calcium to the soybean protein in Examples. However, the gel physical property is lower than that of the product without addition of calcium, and the quality of the gel does not show sufficient gel physical property.

A vegetable protein material can be used for various foods such as beverage and paste product. Thus, a protein material that can be widely used for these foods is desired. However, at present, a vegetable protein material having sufficient water dispersibility and gel physical property has not been obtained.

Therefore, an object of the present invention is to provide a protein material having excellent water dispersibility and excellent gel physical property.

### Means for Solving Problems

The present inventors have extensively studied for the above described problem. As a result, the inventors have found that a mung bean protein material obtained by adding calcium salt to a solution containing mung bean protein, in an amount of 0.04 to 0.5% by weight as calcium based on the solid content, and then drying has excellent water dispersibility and excellent gel physical property. The present invention has been completed based on the findings.

That is, the present invention is:

(1) a process for producing a mung bean protein material including adding calcium salt to a solution containing mung bean protein, in an amount of 0.04 to 0.5% by weight as calcium based on the solid content, and then drying;

(2) the process of (1), where the calcium salt is added in an amount of 0.08 to 0.4% by weight as calcium based on the solid content;

(3) the process of (1) or (2), where the calcium salt is one or two or more of salts selected from the group consisting of calcium hydroxide, calcium lactate, calcium sulfate, and calcium carbonate; and

(4) the process of any of (1) to (3), further including heating the solution to 70° C. to 160° C. after the step of adding calcium salt to a solution containing mung bean protein, in an amount of 0.04 to 0.5% by weight as calcium based on the solid content.

### Effects of Invention

The present invention enables to obtain a mung bean protein material having excellent water dispersibility and excellent gel physical property.

### Mode for Carrying Out Invention

### (Mang Bean Protein-Containing Solution)

A mung bean protein-containing solution of the present invention is prepared by, for example, adding water to raw material such as whole mung bean, dehulled mung bean, defibered mung bean, destarched mung bean and ground product thereof, and then extracting mung bean protein, or making a commercially available mung bean protein to an aqueous solution.

### (Production Process of Mung Bean Protein Material)

A mung bean protein material of the present invention may be obtained by adding a calcium salt to the mung bean protein-containing solution, and then drying.

First, it is necessary to obtain the mung bean protein-containing solution, for example, by extracting mung bean protein from a mung bean raw material. One example of process for producing the mung bean protein-containing solution is a process including: preparing water solution by adding water or hot water to a mung bean raw material and immersing the raw material about 10 hours to hours, and then grinding with a wet grinding machine (grinder etc.) or by pulverizing a mung bean raw material with an apparatus such as pin mill, pulverizer, hammer mill, and jet mill, and then dispersing the pulverized material into water or hot water; and then extracting protein in the vicinity of neutral pH (generally pH 6 to 8) to obtain a solution.

Another example is a process including removing fiber and starch from the water solution, in which mung bean is dispersed into water or hot water, with a mesh, adjusting pH of the defibered and destarched solution to a neutral pH (approximately pH 6 to 8), and then extracting protein to obtain a solution.

Still another example is a process including adjusting pH of the water solution, in which mung bean is dispersed into water or hot water, or the defibered and destarched solution to acidic (approximately pH 4 to 5) to make the protein isoelectric point precipitation, recovering the protein, and then dissolving the recovered protein into water or hot water to obtain a solution.

Examples of a method for adjusting pH of the aqueous solution to acidic range include a method of adding a mineral acid such as hydrochloric acid, sulfuric acid, phosphoric acid, and nitric acid; a method of adding an organic acid such as citric acid, tartaric acid, lactic acid, malic acid, and acetic acid; and a method of adding a lactic acid bacterium.

Examples of water used for obtaining the mung bean protein-containing solution include tap water, natural water, distilled water, and ion exchange water. When the weight ratio of mung bean raw material:water is too small, an efficiency of protein extraction decreases. When the weight ratio is too large, a yield of protein decreases. Thus, the weight ratio of mung bean material:water is preferably 1:6 to 1:12, more preferably 1:7 to 1:11.

The mung bean protein material of the present invention is undegraded which has not undergone hydrolysis by protease. As used herein, “undegraded” means that the 0.22 M trichloroacetic acid (TCA) solubility is preferably 4.5% or less, more preferably 4% or less, further preferably 3.6% or less. In the present invention, the 0.22 M trichloroacetic acid (TCA) solubility is determined by the Kjeldahl method of the ratio of 0.22 M trichloroacetic acid (TCA) soluble protein to the whole protein.

### (Calcium Salt)

Next, calcium salt is added to the mung bean protein-containing solution. Examples of the calcium salt include calcium chloride, calcium hydroxide, calcium lactate, calcium sulfate, and calcium carbonate. Preferably, calcium salt is calcium hydroxide or calcium chloride.

These calcium salts may be used alone or in combination of two or more.

The calcium salt is added in an amount of 0.04 to 0.5% by weight, preferably 0.08 to 0.4% by weight, more preferably 0.1 to 0.3% by weight as calcium based on the solid content in the mung bean protein-containing solution. When the adding amount is too low, dispersibility of the mung bean protein material in water may be deteriorated. When the adding amount is too high, gel formation may be adversely affected.

The mung bean protein-containing solution to which the calcium salt is added is preferably heated. The heating temperature is preferably in the range of 70° C. to 160° C., more preferably 80° C. to 160° C., further preferably 110° C. to 150° C. The heating time is preferably in the range of 2 seconds to 60 minutes, more preferably 5 seconds to 3 minutes, further preferably 5 to 15 seconds.

The heating method is not particularly limited and either indirect heating method or direct heating method may be used. From the viewpoint of improving solubility, for example, it is preferable that high temperature and high pressure steam is directly injected into a mung bean protein-containing solution, and the solution is held with heating, and the pressure is rapidly released in a vacuum flash pan, by using a continuous direct heat sterilizer (for example, manufactured by Alfa Laval Co., Ltd.).

The mung bean protein material of the present invention may be obtained by drying and powderizing the mung bean protein-containing solution obtained as described above. As a method of drying and powdering, it is preferable in terms of quality and manufacturing cost to dry by using a spray dryer. As a method of spray drying, either a disk-type atomizer method or a one-fluid or two-fluid nozzle method may be used.

The mung bean protein material of the present invention obtained as described above has excellent water dispersibility and excellent gel physical property.

As used herein, “excellent water dispersibility” means that powder of mung bean protein material is dispersed in water uniformly, and clumps of powder do not remain when the powder and water are mixed. Excellent dispersibility enables to produce a solution with simple process and provides better workability, in, for example, powder beverage.

Water dispersibility is evaluated by visually observing the state of clumps of mung bean protein material powder in the solution after shaking by a predetermined shaker to be described later. The evaluation is at a score of 1 to 4 points.

As used herein, “excellent gel physical property” means that a gel (dough), which is prepared by mixing a mung bean protein material powder, water and oil uniformly and then heating, is well-combined and has certain elasticity.

Excellent gel physical property provides a function of combining dough and other materials and a stable work in the production of paste product and cheese-like product.

In addition, it prevents quality change, such as texture, color tone, and flavor, over time and maintains good stable quality during storage.

Gel physical property is evaluated by the numerical value of the breaking load measured with Rheoner (manufactured by Yamaden Co., Ltd.) under predetermined conditions to be described later, and 30 gf or more is accepted, more preferably 50 gf or more.

### (Application)

The mung bean protein material of the present invention is excellent in water dispersibility. Thus, it may be used for powder beverage. Further, it may be used for, for example, paste product, cheese-like food, and baked cookie bar, which require gel physical property.

### EXAMPLES

Hereinafter, the present invention will be described in more detail by way of Examples. In the Examples, both of part and % mean weight basis unless otherwise stated.

### Example 1

Mung bean was pulverized with a pulverizer (AP-1SH, manufactured by Hosokawa Micron Corporation). The obtained pulverized mung bean was mixed with water at a ratio of 1:9 and subjected to extraction at pH 7.0. The mixed solution was centrifuged at 3000 rpm for 15 minutes for removing precipitate including starch to obtain a mung bean protein-containing solution. Then, the solution was adjusted to pH 4.5 by adding hydrochloric acid, and then centrifuged at 3000 rpm for 15 minutes to recover the precipitate as a mung bean protein curd.

Next, calcium hydroxide was added in an amount of 0.2% as calcium based on the solid content of the above-mentioned mung bean protein curd. The solution was adjusted to pH 7 with sodium hydroxide, heated at 150° C. for seconds, and then spray dried to obtain a mung bean protein material of the present invention. The obtained mung bean protein material had 3.4% of 0.22 M trichloroacetic acid (TCA) solubility.

### Comparative Example 1

A mung bean protein material was obtained in the same manner as in Example 1 except that calcium hydroxide in Example 1 was not added.

Physical properties (water dispersibility and gel physical property) of the mung bean protein materials obtained in Example 1 and Comparative Example 1 were evaluated by using the evaluation method as shown below. The results are shown in Table 1.

### (Evaluation Method of Physical Property)

### Water Dispersibility

### (Analysis Method)

To 4 g of powder in a predetermined container, 100 mL of tap water was added. The container was covered with the lid and shaken for 20 second with a shaker (NISSIN ROTARY SHAKER NX-20D, manufactured by Nissin Rika Co., Ltd.) with shaking instruments at the constant speed (dial 9, SPEED 160). The state of clumps was visually evaluated on a scale of 1 to 4 points.

### (Evaluation of Dispersibility)

4: Excellent dispersibility without clumps

3: Excellent dispersion, showing no more than 8 small clumps

2: Slightly poor dispersibility, showing more than 9 clumps or remaining powder as is

1: Poor dispersibility, remaining clumps or being covered by powder over ¼ or more of the liquid surface

The product obtaining 3 or 4 points of dispersibility was determined as excellent dispersibility and acceptable.

### Gel Physical Property

### (Analysis Method)

A mixture was prepared by mixing 100 parts of mung bean protein material, 350 parts of water and 150 parts of oil. The mixture was kneaded for 5 minutes with a speed cutter (Robot coupe cutter mixer R-2A), then filled into a casing, and then heated at 85° C. for 30 minutes. After cooling, it was cut to a predetermined thickness, and the breaking load of the gel was measured with Rheoner (manufactured by Yamaden Co., Ltd.).

### (Evaluation of Gel Physical Property)

As a numerical value of the breaking load, 30 gf or more is acceptable, 50 gf or more is more preferable.

TABLE 1

| | | Comparative |
|---|---|---|
| | Example 1 | Example 1 |
| Water dispersibility | 4 | 1 |
| Physical property of | 56 | 74 |
| heated gel (gf) | | |

The mung bean protein material of Example 1 showed excellent water dispersibility and excellent gel physical property. However, the mung bean protein material of Comparative Example 1 in which calcium hydroxide was not added showed excellent gel physical property but poor dispersibility.

### (Study of Adding Amount of Calcium Salt) (Examples 2 to 5, Comparative Examples 2 to 4)

The adding amount of calcium salt was tested. Mung bean protein materials were obtained in the same manner as Example 1 except that calcium hydroxide was added to the mung bean protein curd in each amount of 0.02%, 0.04%, 0.1%, 0.2%, 0.3%, 0.4%, 0.7%, 1.0% as calcium based on the solid content of the curd. As mentioned above, physical properties (water dispersibility and gel physical property) were evaluated. The evaluation results are shown in Table 2.

TABLE 2

| | Com- | | | | | | Com- | Com- |
|---|---|---|---|---|---|---|---|---|
| | parative | Ex- | Ex- | Ex- | Ex- | Ex- | parative | parative |
| | Example | ample | ample | ample | ample | ample | Example | Example |
| | 2 | 2 | 3 | 1 | 4 | 5 | 3 | 4 |
| Calcium | 0.02 | 0.04 | 0.1 | 0.2 | 0.3 | 0.4 | 0.7 | 1.0 |
| content (%) | | | | | | | | |
| Dispersibility | 2 | 3 | 4 | 4 | 4 | 4 | 4 | 4 |
| Physical | 72 | 69 | 60 | 56 | 51 | 41 | 10 | 4 |
| property of | | | | | | | | |
| heated gel | | | | | | | | |
| (gf) | | | | | | | | |

### (Study of Soybean Protein Material) (Comparative Examples 5 to 9)

To 10 kg of defatted soybean, 15 times amount of water was added. The solution was adjusted to pH 7.0 with 1 N NaOH, and subjected to stirring extraction with a homomixer at room temperature for 30 minutes. The bean curd refuse (okara) component was removed by using a centrifuge (3000×g, 15 minutes) to obtain a defatted soymilk. The defatted soymilk was adjusted to pH 4.5 with 1N HCl, and then subjected a centrifugation (3000×g, 15 minutes) to recover the precipitate as a soybean protein curd.

Calcium hydroxide was added to the above obtained soybean protein curd in each amount of 0.02%, 0.04%, 0.2%, 0.7%, 1.0% as calcium based on the solid content of the curd. The solution was adjusted to pH 7 with a sodium hydroxide to prepare a soybean protein-containing solution. Then, the solution was heated at 150° C. for 10 seconds, and then spray dried to obtain a soybean protein material.

The obtained soybean protein material was evaluated in the same manner as Example 1. The evaluation results are shown in Table 3.

TABLE 3

| | Comparative | Comparative | Comparative | Comparative | Comparative |
|---|---|---|---|---|---|
| | Example 5 | Example 6 | Example 7 | Example 8 | Example 9 |
| Calcium content | 0.02 | 0.04 | 0.2 | 0.7 | 1.0 |
| (%) | | | | | |
| Dispersibility | 1 | 1 | 2 | 4 | 4 |
| Physical property | 82 | 76 | 70 | 18 | 6 |
| of heated gel (gf) | | | | | |

In the case of the soybean protein material, it was necessary to add calcium to some extent in order to improve dispersibility as shown in Comparative Examples 8 to 9, but the gel physical property was remarkably deteriorated. In addition, when the adding amount of calcium was lowered as shown in Comparative Examples 5 to 7, the gel physical property became good, but the dispersibility became poor.

Therefore, soybean protein material having excellent dispersibility and excellent gel physical property similar to the mung bean protein material of the present invention was not obtained.

1. A process for producing a mung bean protein material comprising adding calcium salt to a solution containing mung bean protein, in an amount of 0.04 to 0.5% by weight as calcium based on the solid content, and then drying.

2. The process according to claim 1, wherein the calcium salt is added in an amount of 0.08 to 0.4% by weight as calcium based on the solid content.

3. The process according to claim 1, wherein the calcium salt is one or two or more of salts selected from the group consisting of calcium hydroxide, calcium lactate, calcium sulfate, and calcium carbonate.

4. The process according to claim 1, further comprising heating the solution to 70° C. to 160° C. after the step of adding calcium salt to a solution containing mung bean protein, in an amount of 0.04 to 0.5% by weight as calcium based on the solid content.

5. The process according to claim 2, wherein the calcium salt is one or two or more of salts selected from the group consisting of calcium hydroxide, calcium lactate, calcium sulfate, and calcium carbonate.

6. The process according to claim 2, further comprising heating the solution to 70° C. to 160° C. after the step of adding calcium salt to a solution containing mung bean protein, in an amount of 0.04 to 0.5% by weight as calcium based on the solid content.

7. The process according to claim 3, further comprising heating the solution to 70° C. to 160° C. after the step of adding calcium salt to a solution containing mung bean protein, in an amount of 0.04 to 0.5% by weight as calcium based on the solid content.

8. The process according to claim 5, further comprising heating the solution to 70° C. to 160° C. after the step of adding calcium salt to a solution containing mung bean protein, in an amount of 0.04 to 0.5% by weight as calcium based on the solid content.
